(19) United States
(12) Patent Application Publication
(10) Pub. No.: US 2011/0197485 A1
(43) Pub. Date: Aug. 18, 2011

(54) Denise's candle photo frames

(76) Inventor: Denise Bryant, Houston, TX (US)

(21) Appl. No.: 12/931,425

(22) Filed: Jan. 31, 2011

Related U.S. Application Data
(60) Provisional application No. 61/337,050, filed on Jan. 29, 2010.

(51) Int. Cl. A47G 1/06; F21V 35/00

(52) U.S. Cl. 40/715

(57) ABSTRACT

The present invention provides a picture frame mounted onto a base with at least one candle holder, which illuminate the image contained within as well as provides a festive alternative to traditional frames. The present invention provides consumers a unique and striking means of showcasing favorite photos. Denise's Candle Photo Frames is produced from a variety of materials. One embodiment is composed of heavy duty plastic with other embodiments fabricated from ceramic, glass, resin and metal, each embodiment is made with a multitude of color options, designs and finishes. Denise's Candle Photo Frames are manufactured in an array of sizes for use with two inch by two inch wallet size photographs, three inch by three inch Polaroid's, three inch by five inch and five by seven inch snapshots; as well as eight inch by ten inch and eleven inch by fourteen inch prints. As with standard picture frames, Denise's Candle Photo Frames feature glass picture plates, and are integrated with hinged picture stands and hanging hardware.

### CLAIM OF PRIORITY

This patent application claims priority under 35 USC 119(e)(1) from U.S. Provisional Patent Application Ser. No. 61/337,050 filed Jan. 29, 2010, of common inventorship herewith entitled, “Denise's Candle Photo Frames.”

### FIELD OF THE INVENTION

The present invention pertains to the field of photograph storage and display systems, and more specifically to the field of illuminated picture frames.

### BACKGROUND OF THE INVENTION

The prior art has put forth several designs for illuminated picture frames. Among these are:

U.S. Pat. No. 1,884,290 to William C. Schults and Max Holzer describes a frame for exhibiting and illuminating religious and other pictures, and to provide means to prevent the frame from becoming heated by the illuminating means. The invention also comprehends a frame, the front and the rear of which are spaced apart, there being a guideway at the rear of the frame in which a picture may be disposed, and there being a transparent member at the front of the frame, the picture being illuminated by a lamp below the frame and there being outlet openings at the top of the frame and inlet openings at the bottom of the frame to permit a column of cooling air to pass upwardly between the transparent member and the picture.

U.S. Pat. No. 4,001,959 to Russell S. Grendahl describes new and improved interior decorating apparatus comprising a three-dimensional picture frame. Means are provided for displaying a plurality of pictures around the periphery of a polyhedral or semipolyhedral body in a plurality of openings defined by a top, a bottom, and spacers extending therebetween and grooved to support, display, and protect the pictures.

U.S. Pat. No. 4,942,685 to Ling-Yung Lin describes a photo frame with a hidden light illumination loop made of light transmitting material, a DC or AC operated light source which can provide necessary light delivered by the light illumination loop all around the frame and cast on the photo located within the frame.

None of these prior art references describe the present invention.

### SUMMARY OF THE INVENTION

It is an object of the present invention to provide a picture frame device illuminated by candles.

### BRIEF DESCRIPTION OF THE DRAWINGS

FIG. 1 is an elevational angled perspective view of the device of the present invention.

FIG. 2 is an elevational angled perspective view of an alternative embodiment of the device of the present invention.

FIG. 3 is an elevational angled perspective view of a further alternative embodiment of the device of the present invention.

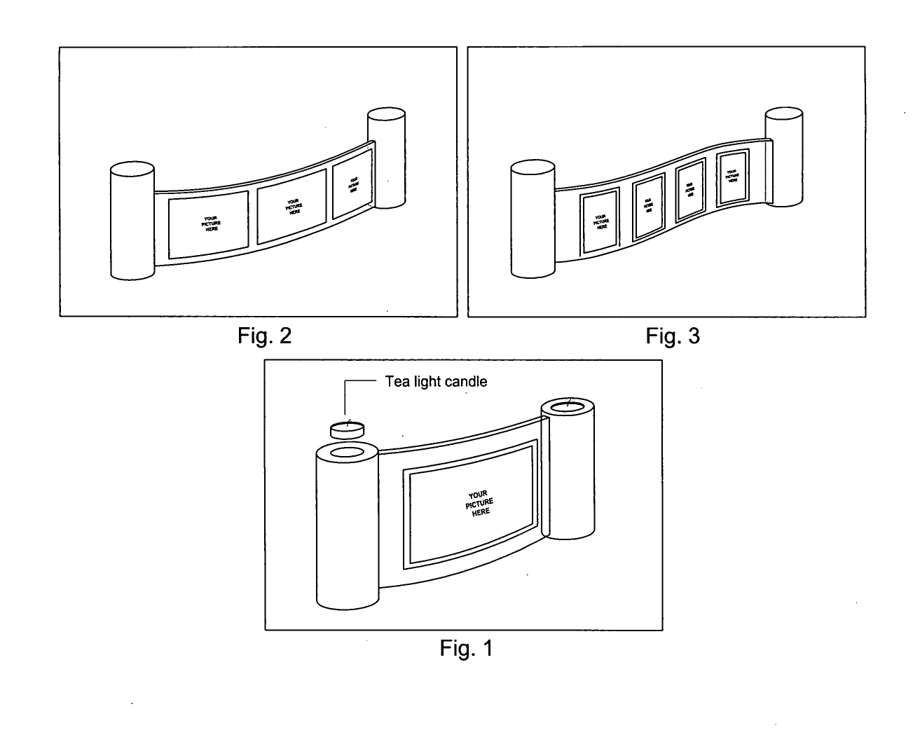

### DETAILED DESCRIPTION OF THE INVENTION

A favorite means of preserving memories is through photography. A photograph provides a lasting keepsake of special moments in life. A baby's first steps, a child's first day of school, a college graduation or a loved one's wedding can all be beautifully captured on film, providing an instant reminder of a cherished day. Additionally, photography is used to record those often overlooked, candid moments which make life so special. Children skipping over a sprinkler, two elderly men playing chess in the park or a young couple sharing a tender moment, are all memories that would be soon forgotten if not printed in living color or black and white. Powerful and dynamic, a photograph can provide a visual reminder of family, friends and events, while affording future generations a glimpse into the past.

Although most people consider photographs to be amongst their most prized possessions, finding a way to properly display them is a problem. Other than a few, predictable framed prints on a wall, most people keep the majority of their photographs hidden from view. All too often, photos are left in the envelopes they came in after being developed, or are misplaced and forgotten, tucked in drawers and packed away in stacks of old boxes. Hidden from sight in dusty photo albums and storage trunks, photographs can deteriorate if not cared for properly, as can the memories and image that the photo once faithfully captured.

The present invention, hereinafter referred as Denise's Candle Photo Frames, is an entire line of dramatically different picture frames boasting integrated candle holders which illuminate the image contained within as well as provides a festive alternative to traditional frames. This provides consumers a unique and striking means of showcasing favorite photos. Denise's Candle Photo Frames is produced from a variety of materials. One embodiment is composed of heavy duty plastic with other embodiments fabricated from ceramic, glass, resin and metal, each embodiment is made with a multitude of color options, designs and finishes. Denise's Candle Photo Frames are manufactured in an array of sizes for use with two inch by two inch wallet size photographs, three inch by three inch Polaroid's, three inch by five inch and five by seven inch snapshots; as well as eight inch by ten inch and eleven inch by fourteen inch prints. As with standard picture frames, Denise's Candle Photo Frames feature glass picture plates, and are integrated with hinged picture stands and hanging hardware. As mentioned, the most notable aspect of Denise's Candle Photo Frames is found in the integrated candle holders. Positioned on each end of the frame is a simple, circular shaped plate, on which decorative candles, included for sale with the frame are elegantly displayed. For hanging picture frames, decorative sconces are included in yet another embodiment. Denise's Candle Photo Frames are configured to hold one, two or several candles, with a wide variety of designs.

Use of Denise's Candle Photo Frames is very simple and straight forward. Consumers simply purchase various frames from the collection which best suits specific photographs and their personal framing needs. By way of example, a sleek black wooden frame adorned with two, vanilla scented pillar candles prove an attractive display for a favorite landscape photograph when hung on a family room wall. Once purchased, Denise's Candle Photo Frames is filled with the appropriate photograph in a similar manner as any other picture frame, by sliding the picture through a slotted opening at the top of the frame or, in another embodiment, by removing a hinged panel on the back of the frame and placing the photograph directly within. The user then inserts the included candles within the candle holders and displays Denise's Candle Photo Frames utilizing the integrated picture stands or hanging hardware according to easily followed package instructions. During the evening hours, the user simply lights the decorative candles, creating a brilliant, illuminated display.

There are many benefits and advantages associated with Denise's Candle Photo Frames. Foremost, Denise's Candle Photo Frames provides consumers with a unique means of proudly displaying favorite photographs. Boasting integrated candle holders which beautifully illuminate the displayed image, Denise's Candle Photo Frames offer an attractive and distinct alternative to traditional frames. Enabling consumers to display their favorite photographs in a truly personalized and dynamic manner, these illuminated picture frames look appealing when displayed on a mantel, placed on a night stand or hung on a wall, transforming simple images into well lighted pieces of art. A decorative object with which to bring a sense of cozy warmth to a family room, study or den, Denise's Candle Photo Frames also serve the functional purpose of providing consumers a striking and unique light source with which to enliven their home's interior during the evening hours. Produced in a wide variety of styles and designs, there are Denise's Candle Photo Frames available to suit the endless imagery and unique personalities of those captured on film. More than a mere picture frame, Denise's Candle Photo Frames enables consumers to transform a simple photo into a treasured keepsake to be passed down through generations. A beautiful gift, a Denise's Candle Photo Frames, handpicked to represent the personality and interests of the recipient, prove a thoughtful and generous token shared at birthday parties, anniversary gatherings and especially during the holidays. Because photos displayed in Denise's Candle Photo Frames are carefully sealed under glass, they remain colorful and vivid, even after years of enjoyment. Extending the life of the image, use of Denise's Candle Photo Frames effectively ensures that treasured memories do not fade, tear or deteriorate over time.

Denise's Candle Photo Frames is a uniquely designed product invention that turn an ordinary photograph into a customized showpiece. Innovative and unique, these dazzling, illuminated picture frames offer consumers an effective means of proudly displaying cherished memories.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A picture frame device, comprising:
a picture frame for sitting on a horizontal surface having at least one integrated candle holder, wherein the frame has a first end and a second end.

2. The device of claim 1 having two candle holders, wherein the first candle holder is located at the first end of the frame and the second candle holder is located at the second end of the frame.

2. The device of claim 1 comprising heavy duty plastic material.

3. The device of claim 1 comprising ceramic material.

4. The device of claim 1 comprising glass.

5. The device of claim 1 comprising resin material.

6. The device of claim 1 comprising metal.

7. The device of claim 1 wherein the picture frame is capable of holding a multiplicity of photographs.

8. The device of claim 1 wherein the device comprises a multiplicity of candle holders.

9. The device of claim 1 wherein the candle holder is configured to hold a tea light candle.

10. A picture frame device, comprising:
a picture frame for hanging on a wall having at least one integrated candle holder, wherein the frame has a first end and a second end.
